(19) United States
(12) Patent Application Publication
(10) Pub. No.: US 2006/0073743 A1
(43) Pub. Date: Apr. 6, 2006

(54) Welded electrical connector and machine to make same

(76) Inventors: Tim Ford, Dayton, OH (US); Barry Reis, Morrow, OH (US)

Correspondence Address: Law Office of William B. Ritchie, 43 Jackson Street, Concord, NH, 03301, US

(21) Appl. No.: 11/244,871

(22) Filed: Oct. 6, 2005

Related U.S. Application Data
(60) Provisional application No. 60/616,430, filed on Oct. 6, 2004.

(51) Int. Cl. H01R 4/10

(52) U.S. Cl. 439/877

(57) ABSTRACT

A machine that will remove the lacquer type of insulation in the region of the crimp of a terminal without requiring the terminal connector to be moved. The machine can use any type of terminal connector that has at least one wire having this type of insulation. The machine will improve upon mechanical connection as a result of heating the terminal in the region of the legs of the crimp, which can in some cases actually weld the wire to the terminal. A terminal connector that has an improved connection between the wire and the terminal without the need for skiving the terminal in order to remove the lacquer type of insulation is also disclosed. The invention can be adapted to use any wire type combination of insulated wires provided at least one wire is coated with a lacquer type of insulating material. The terminal connector is otherwise a standard type except for the connection improvement in the region of the crimp.

### FIELD OF THE INVENTION

This invention relates to electrical terminal connections, in particular, a machine to make a welded or heat staked electrical terminal connection.

### BACKGROUND OF THE INVENTION

Present electrical terminal connections such as made by AMP electrical terminal, a Division of Tyco Electronics, use only a mechanical connection between the wire and the terminal. This style of terminal is made by skiving sharp grooves in the metal of the terminal housing. These grooves are sufficiently sharp to cut through the lacquer-type of magnet wire insulation of the wire that is inserted therein. Thus, the electrical connection between the wire and the metal terminal housing depends solely on the sufficiency of the mechanical connection between the two.

Current crimping machines do not allow the terminal connector to be welded to burn away this lacquer insulation without the terminal having to be moved in some way. Since the connector wires with the terminal connection are wound on bulky electrical apparatus, such as wound motors, it is not possible to efficiently weld the connector using present techniques because the state of the art methods require moving the terminals. This extra step would also require more work for the machine operator.

There is not found in the prior art an apparatus that enables an operator to make a welded electrical connector that can be welded in the region of the crimped legs of the terminal so that the operator merely has to put the wire into the proper location on the apparatus and the apparatus will crimp and weld the terminal connector and feed the next terminal into place and so on.

### SUMMARY OF THE INVENTION

It is an aspect of the invention to provide a machine that will remove the lacquer type of insulation in the region of the crimp without requiring the terminal connector to be moved.

It is another aspect of the invention to provide a machine that can use any type of terminal connector that has at least one wire having this type of insulation. Examples of some of the common types of terminal connectors that can be used with the invention are shown in FIG. 5.

Another aspect of the invention is to improve the mechanical connection as a result of heating the terminal in the region of the crimp, which can, in some cases, actually weld the wire to the terminal.

It is another aspect of the invention to provide a terminal connector that has an improved connection between the wire and the terminal without the need for skiving the terminal in order to remove the lacquer type of insulation.

It is still another aspect of the invention to provide a terminal connector that can be adapted for use on any wire type combination of insulated wires provided at least one wire is coated with a lacquer type of insulating material.

Finally, it is an aspect of the invention to provide a terminal connector that is otherwise a standard type except for the connection improvement in the region of the crimp.

These and other aspects of the invention will become apparent in light of the detailed description of the invention which follows.

### BRIEF DESCRIPTION OF THE DRAWINGS

FIG. 1 is an isometric view of the terminal connector in accordance with the invention.

FIG. 2 is an isometric view of the terminal connector with one magnet wire attached therein.

FIG. 3 is a side view of the machine used to make the terminal connector showing the crimping operation.

FIG. 4 is a side view of the machine in FIG. 3 showing the heating/welding operation of the invention.

FIG. 5 is an isometric view of some of the varying type of terminal connectors that can be used with the invention.

### DESCRIPTION OF THE PREFERRED EMBODIMENTS

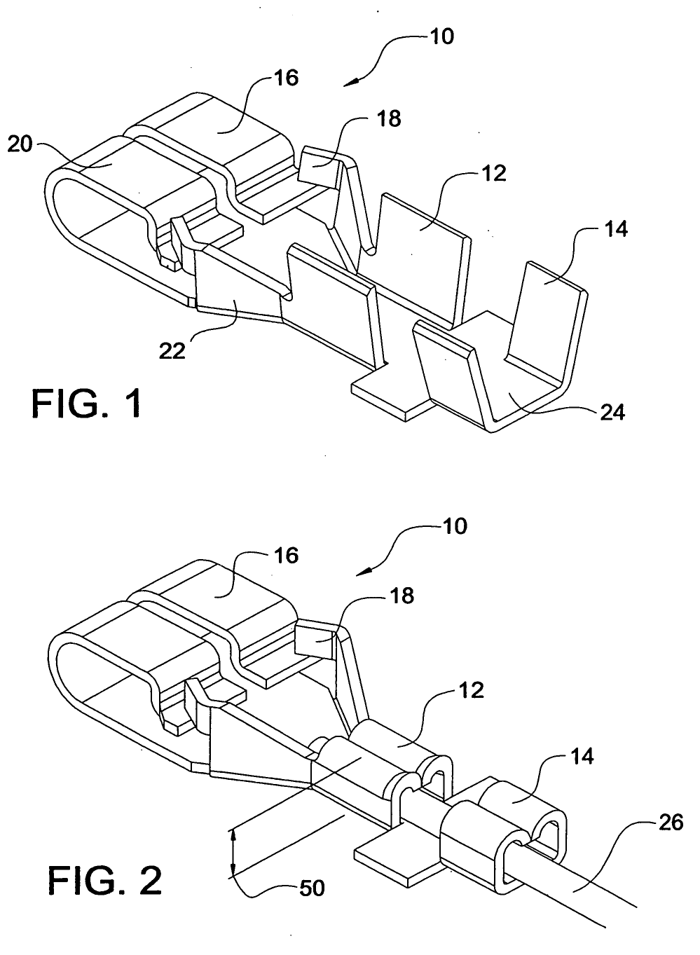

Referring now to FIG. 1, the invention uses a terminal connector invention 10 that is similar to such connectors which are well known in the art. As noted above, this example is only one of a plethora of terminal connectors that can be used with the invention. The connector is stamped from a flat metal sheet such as brass, copper or other metal well known in the art for such use. Opposing pairs of conductor crimp legs 12 and strain relief legs 14 are then folded so that legs 12 and 14 are approximately at right angles to base 24. Then terminal pin receptacle connector tab 16 is folded and locked into place via locking tab 18. Note that a pair of connector tabs 16 and 20 are used; however, a single tab or any of the connection tabs well known in the art could be used. Terminal connectors 10 are fed into the machine on a reel and then cut off as needed.

As shown in FIG. 2, Magnet wire 26 is fed into the machine via the operator. Magnet wire 26 having at least one wire coated with a lacquer type of insulating material, well known in the art is placed in base 24 and leg pairs 12 are crimped around as is done with prior art crimped connectors. A second pair of legs 14 is provided and legs 14 are also crimped around wire 26 for strain relief or for grasping wire insulation or sleeving on wire 28. The crimped terminal 10 is then heated and/or welded on the conductor crimp legs 12 to burn away the insulation. This creates a better contact which is both mechanical and electrically sound. As discussed above, wire that has other strands covered by non-lacquer insulation along with at least one strand having lacquer insulation could also be used. The non-lacquer insulation strands would have to be stripped using techniques well known in the art before placing the wire into the terminal connector 10.

Depending on the requirements, type of wire used, diameter, etc., in some cases merely the insulation is burned away to provide the electrical connection between the metal wire and the metal connector. However, in other situations, the metal to metal connection is actually a weld. With the invention, the crimp height 50 is not as critical as found using standard crimp methods and connectors. The weld parameters can be set so that crimp height 50 becomes relatively unimportant as the welding process can compensate for a widely toleranced crimp height 50.

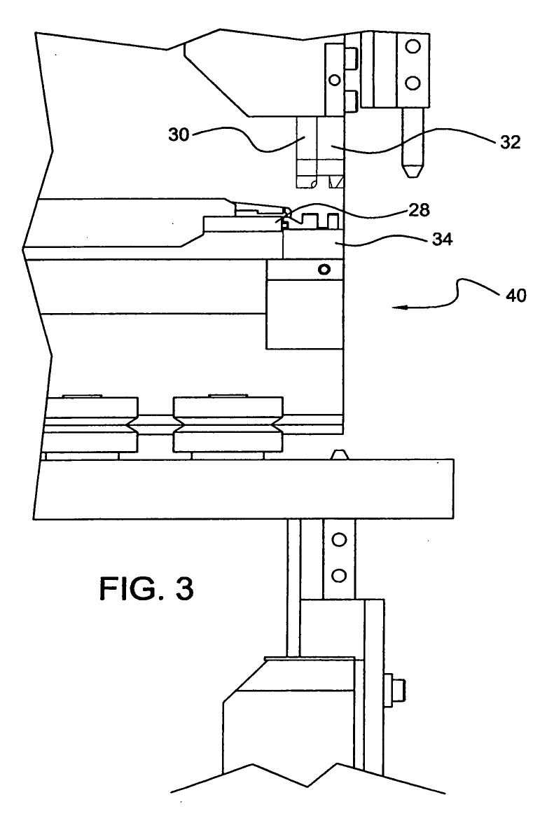

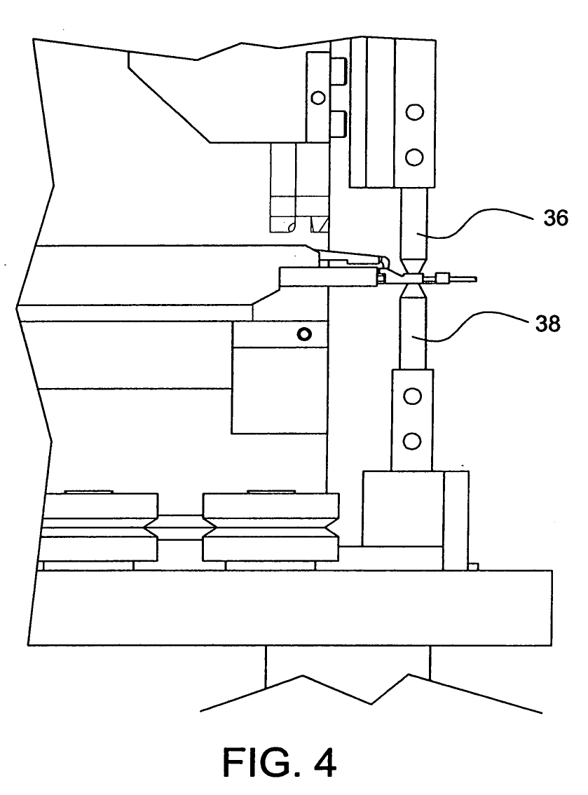

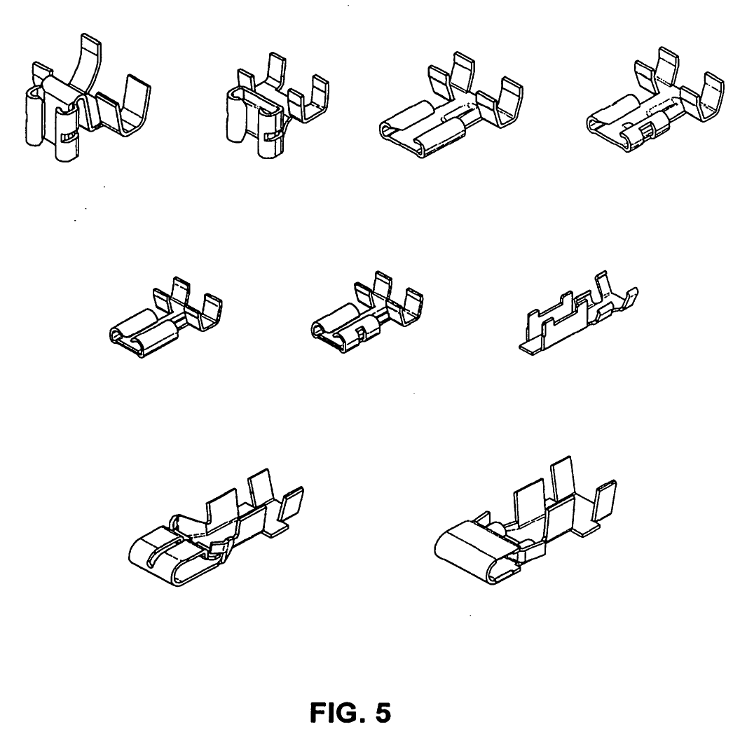

As shown in FIGS. 3 and 4, the machine 40 that provides the welded crimped connecting terminal invention is described. The crimping portion of machine 40 is similar to present machines. The uncrimped terminal connector such as the type shown in FIG. 1 is fed into machine 40 using techniques well known in the art. The uncrimped terminal is held in position using gripper 28. One or more unstripped wires 26 are fed into base 24 between opposing crimp leg pairs 14 and 12. An operator (not shown) cycles machine 40 via a foot pedal (not shown) or other toggling device, well known in the art. Machine 40 then crimps terminal 10 with crimp punches 30 and 32 on anvil 34. The top of machine 40 slides back while gripper 28 continues to hold the now crimped terminal 10 in place so that the crimped terminal does not move. This is shown in FIG. 4. Once the crimping portion of machine 40 is fully back, a top weld/fusion electrode 36 is aligned with a bottom weld/fusion electrode 38. The electrodes then close on the terminal and heats the terminal only in the region of legs 12 until the insulation burns off and a connection is established between the wires and the terminal. As noted above, in some cases, a weld is actually achieved between the wires and the terminal. The electrodes 36 and 38 move away from the terminal and gripper 28 releases the terminal 10. The cycle repeats by machine 40 feeding the next terminal, hand feeding the wire and so on.

While certain representative embodiments of the invention have been described herein for the purposes of illustration, it will be apparent to those skilled in the art that modification therein may be made without departure from the spirit and scope of the invention.

What is claimed is:

1. A crimping machine for crimping an electrical terminal having wire holding legs to at least one electrical wire having a lacquer type of insulation, said machine comprising:
a top that slides back;
a gripper that has the uncrimped terminal inserted thereon;
a crimper to crimp the legs of the terminal; wherein the top of said machine slides back while gripper continues to the crimped legs of said terminal that does not move;
a top weld/fusion electrode that is aligned with a bottom weld/fusion electrode wherein said electrodes close on said terminal heating said terminal only in the region of the legs until the insulation burns off and a connection is established between said at least one wire and said terminal.

2. An improved electrical terminal for connecting to at least one electrical wire having a lacquer type of insulation:
a pair of opposing legs that first mechanically crimped around said at least one electrical wire and wherein said pair of opposing legs are welded to form a metal to metal connection between said opposing legs and said at least one wire and to burn off the lacquer insulation of said at least one wire.

3. An improved electrical terminal for connecting to at least one electrical wire having a lacquer type of insulation:
a pair of opposing legs that first mechanically crimped around said at least one electrical wire and wherein said pair of opposing legs is heated to burn off the lacquer insulation of said at least one wire.

4. The electrical terminal of claim 2 wherein a second wire having an insulating coating that must be stripped off is also placed in said terminal.

5. The electrical terminal of claim 3 wherein a second wire having an insulating coating that must be stripped off is also placed in said terminal.
